(19) United States
(12) Patent Application Publication
(10) Pub. No.: US 2009/0198768 A1
(43) Pub. Date: Aug. 6, 2009

(54) ASYNCHRONOUS REQUEST-RESPONSE COMMUNICATION METHOD

(75) Inventors: Wei Gao, Tianjin (CN); Tom Chen, Taipei (TW); Win-Harn Liu, Taipei (TW)

Correspondence Address: STEVENS & SHOWALTER LLP, 7019 CORPORATE WAY, DAYTON, OH, 45459-4238, US

(73) Assignee: INVENTEC CORPORATION, Taipei (TW)

(21) Appl. No.: 12/023,543

(22) Filed: Jan. 31, 2008

(51) Int. Cl. G06F 15/16

(52) U.S. Cl. 709/203

(57) ABSTRACT

An asynchronous request-response communication method is applied in data transmission for applications running in a server. The asynchronous request-response method includes the following steps. Establish a socket and a connection port corresponding to a request in a request side; set an object pool in each request side respectively, for recording connection statuses of the sockets corresponding to different requests; wait till the server has finished the request; once the server has finished the received request, the server transmits a callback message to the corresponding socket of the request side; and search a corresponding process event in the object pool according to the callback message. The request side adopts the socket and the connection port to perform the asynchronous request-response operations, thereby reducing the connection load between the server and the request side.

### BACKGROUND OF THE INVENTION

1. Field of the Invention

The present invention relates to a request-response communication method, and more particularly to an asynchronous request-response communication method applied in an application running in a server and applied in information transmission between an application and a request side.

2. Related Art

In order to achieve the purpose of real-time response, a common application generally adopts an asynchronous request-response mechanism. The asynchronous request-response may be achieved through two modes, i.e., thread polling and callback. Referring to FIGS. 1a and 1b, they are an architecture diagram of a conventional thread monitoring process and a flow chart of an operation of a conventional thread, respectively.

FIG. 1a shows a request side 110 and a server 120. The request side 110 in FIG. 1a has a plurality of threads 111. The request side 110 has a polling mechanism for the threads 111, for monitoring whether the request side 110 makes a response or not to a request-response sent by the server 120. The polling operation for the threads 111 is shown in FIG. 1b, and includes the following steps. The request side sends a plurality of requests to the server (Step S150), in which each request corresponds to a request thread 111. An application may have many threads. The operation statuses of the thread 111 respectively include run, block, and ready.

The request side respectively polls each request thread whether it has received the response from the server or not (Step S160). If a request thread has received the response from the server, the request side determines whether to continue this thread or not (Step S170). If the request side continues this thread, Step S160 is repeated (Step S171). Otherwise, the request side removes this thread (Step S172).

As for the polling mechanism of the thread 111, the server 120 needs to continuously collect information and make responses to the polling of the thread 111, which consumes operation resources (for example, CPU operation or memories) in the server 120. Furthermore, the server 120 needs to spend some time in making response to each thread 111, meanwhile the threads 111 have polling intervals, and as a result, it is unavoidable for the threads 111 to lose information.

The other asynchronous request-response mode adopts a callback mechanism. Referring to FIG. 2, it is a flow chart of an operation of a conventional callback mechanism. The request side 110 sends an asynchronous remote program call (RPC) request to a server (Step S210). The controlling right of the request is transferred from the request side to the runtime environment of the request side, and the runtime environment of the request side plays the role of the request side to send the request to the server (Step S220). When the request is transmitted to the server, an application of the server begins executing the remote call (Step S230). After the server finishes the remote call, it sends an execution result back to the request side (Step S240). Then, the request side calls the runtime environment thereof and receives the execution result sent from the server (Step S250).

The disadvantage of the callback mechanism lies in that, it is merely applicable for the information transmission over networks, and once being applied within the server 120, it may consume more resources and increase the system burden.

### SUMMARY OF THE INVENTION

In view of the aforementioned problems, the present invention is mainly directed to an asynchronous request-response communication method, which is especially applicable for information transmission of applications running in a server.

In order to achieve the aforementioned object, the asynchronous request-response communication method provided by the present invention includes the following steps: establishing a socket and a connection port corresponding to a request-response in a request side; setting an object pool in each request side respectively, for recording connection statuses of the sockets corresponding to different request-responses; waiting till the server has finished the request-response; sending a callback message back to the corresponding socket of the request side; and searching a corresponding process event in the object pool according to the callback message.

In the present invention, the request side adopts the socket and the connection port to perform the asynchronous request-response operations, thereby reducing the connection load of making requests/responses for applications between the server and the request side and ensuring the continuity and completeness of the obtained data.

### BRIEF DESCRIPTION OF THE DRAWINGS

The present invention will become more fully understood from the detailed description given herein below for illustration only, which thus is not limitative of the present invention, and wherein:

FIG. 1a is an architecture diagram of a conventional thread monitoring process.

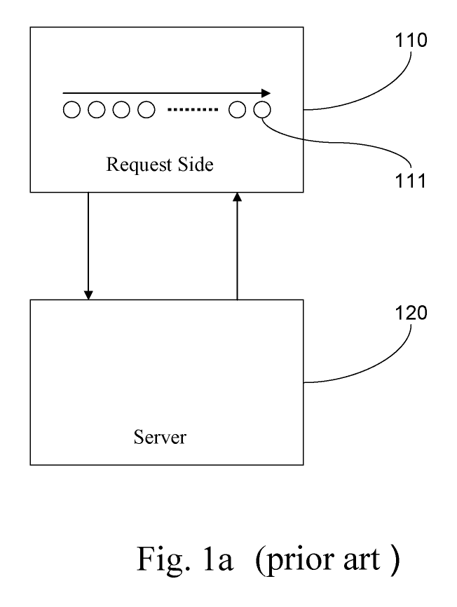

FIG. 1b is a flow chart of an operation of a conventional thread.

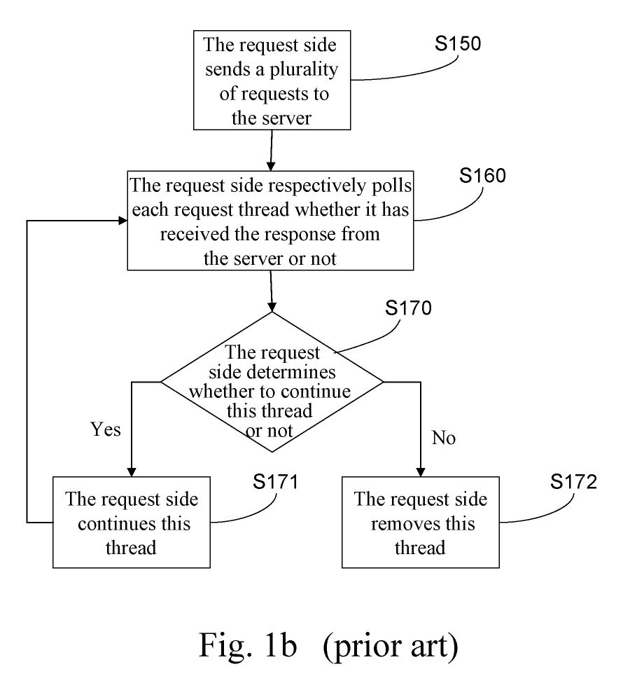

FIG. 2 is a flow chart of an operation of a conventional callback mechanism.

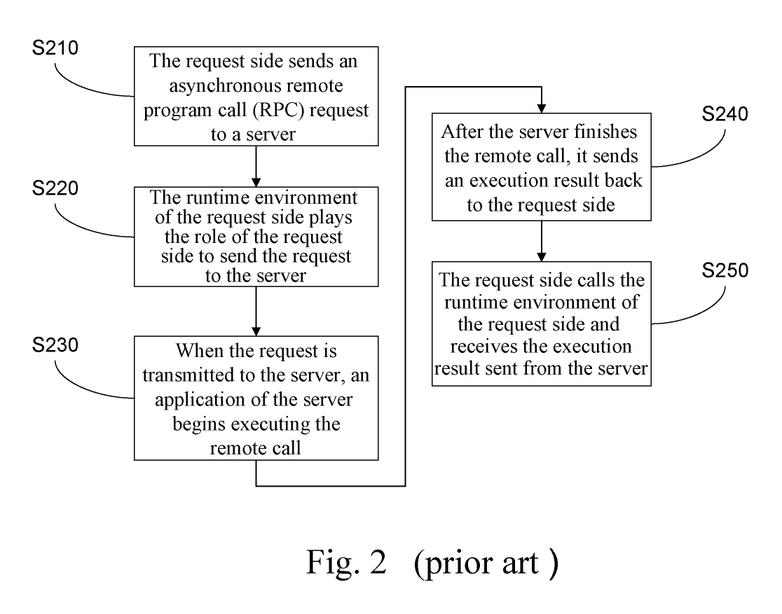

FIG. 3a is an architecture diagram of a system of the present invention.

FIG. 3b is a flow chart of an operation of the present invention.

FIG. 3c is a schematic view of an operation of a thread of the present invention.

### DETAILED DESCRIPTION OF THE INVENTION

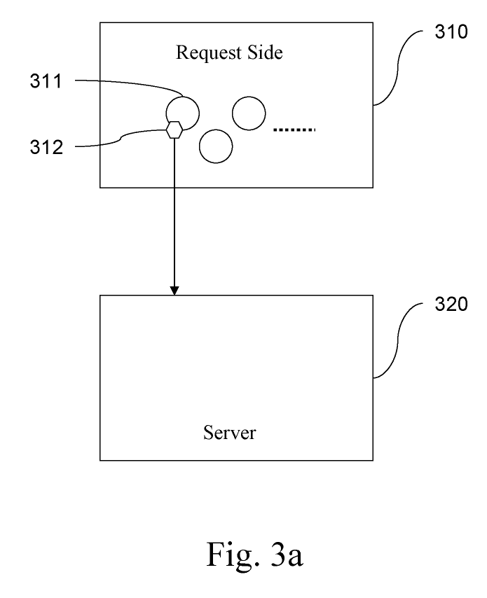

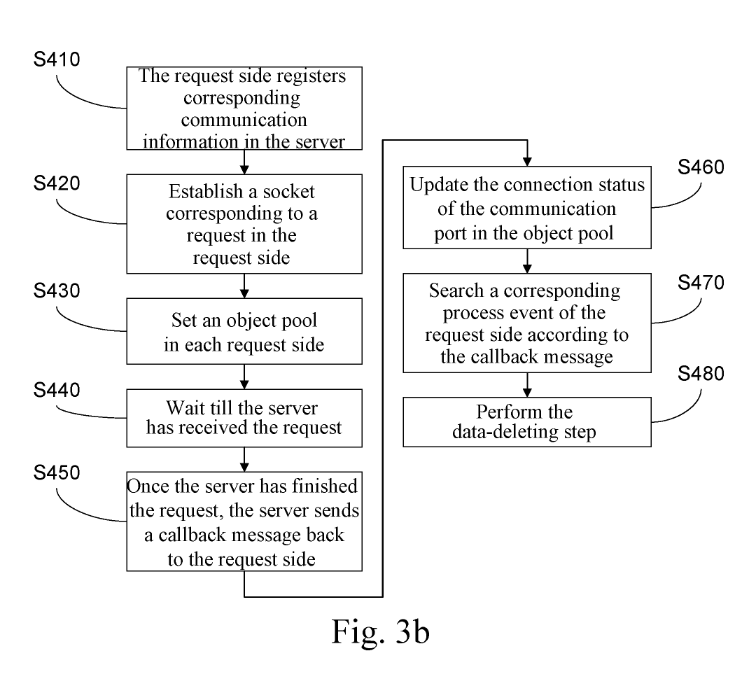

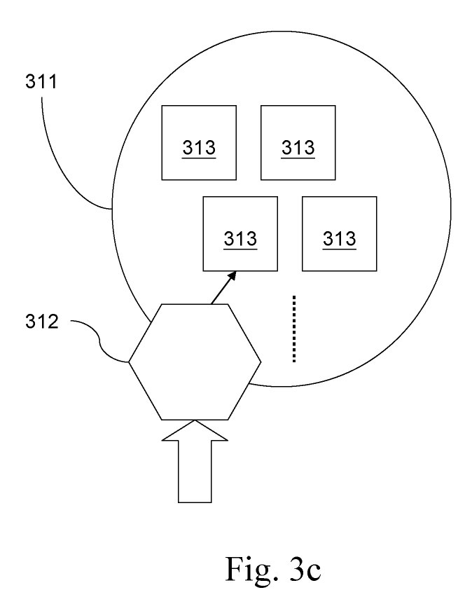

The present invention provides an asynchronous request-response communication method between a server and a request side, which is especially applicable for applications running in the server to make a response to a request sent from the request side. Referring to FIGS. 3a and 3b, they are an architecture diagram of a system of the present invention and a flow chart of an operation of the present invention, respectively. FIG. 3a respectively shows a request side 310 and a server 320. The request side includes an object pool 311, a connection port 312, and a thread 313. Different from the prior art, the asynchronous request-response in the present invention is not achieved through polling or remote call request of the thread 313.

Firstly, the request side registers corresponding communication information in the server (Step S410), so that the server confirms a socket to be used by the request side according to the communication information. Next, a socket corresponding to a request is established in the request side (Step S420). Step S410 and Step S420 are initialization processes for sending a request and making a response to the request side 310 and the server 320 respectively. The socket provides a communication method among applications, and it is mainly used for the information exchange between two different applications. In the application, a different identification code is set correspondingly to each socket. Therefore, when information is exchanged between the applications, the two applications may establish a communication channel according to the unique identification code.

Then, a connection port 312 is further established in the socket, and it is provided for the corresponding application to make communications. In a preferred embodiment, a plurality of connection ports 312 may be established in each socket depending upon the number of the requests, so as to make communications with the server.

Then, an object pool is set in each request side (Step S430). The object pool 311 is used to record the connection status between the socket and the connection port 312 corresponding to each request. During the communication process, the connection status between the socket and the server is determined (Step S440). If the request side 310 and the server 320 are disconnected, the socket sends a connecting request to the server 320 once again. Otherwise, Step S440 is continued to determine the connection status between the request side 310 and the server 320.

Then, the process waits till the server has received the request (Step S450). Once the server has finished the request, the server sends a callback message back to the request side (Step S460). It should be particularly noted that, after the request side 310 sends a request to the server 320, the request side 310 performs additional calculation of other applications or resource invocation. Since the server 320 adopts an asynchronous process, the server 320 will not send a callback message to the request side 310 immediately. The request side 310 may wait for a certain time period, and during this waiting period, the request side 310 may run other applications.

Then, a corresponding process event is searched in the object pool according to the callback message (Step S470). If the request side 310 obtains a process event corresponding to the callback message in the object pool 311 through searching, the request side 310 invokes the process event to be used by the corresponding application. Then, a data-deleting step is performed (Step S480). If no corresponding process event can be searched in the object pool 311 according to the callback message received by the request side 310, the request side 310 performs the data-deleting step to delete the callback message. Referring to FIG. 3c, it is a schematic view of an operation of a thread of the present invention.

In the present invention, the request side adopts the socket and the connection port to perform the asynchronous request-response operations, thereby reducing the connection load of making requests/responses for applications between the server and the request side and ensuring the continuity and completeness of the obtained data.

What is claimed is:

1. An asynchronous request-response communication method, applied in a plurality of applications running in a server, wherein the applications are used to receive a request from a plurality of request sides, the asynchronous request-response method comprising:
establishing a socket and a connection port corresponding to the request in the request side;
setting an object pool in each request side respectively, for recording connection statuses of the sockets corresponding to the requests;
waiting till the server has received the requests;
once the server has finished the received requests, the server responding a callback message back to the request side; and
searching a corresponding process event in the object pool according to the callback message.

2. The asynchronous request-response communication method as claimed in claim 1, wherein before the request side sends a request, the method further comprises a step that the request side registers corresponding communication information in the server, so that the server confirms the socket to be used by the request side according to the communication information.

3. The asynchronous request-response communication method as claimed in claim 1, wherein after the step of searching in the object pool, the method further comprises:
if no corresponding process event is found after searching in the object pool according to the callback message received by the request side, executing a data-deleting step to delete the callback message.

4. The asynchronous request-response communication method as claimed in claim 1, wherein after the step of establishing the socket, the method further comprises:
if the socket and the server are disconnected, the socket sends a connecting request to the server once again.
